(19) United States
(12) Patent Application Publication
(10) Pub. No.: US 2015/0151150 A1
(43) Pub. Date: Jun. 4, 2015

(54) FIRE SUPPRESSION SYSTEM

(71) Applicant: MARIOFF CORPORATION, Vantaa (FI)

(72) Inventors: Michael Kenneth Krager, Linwood, MA (US); Arto Huotari, Helsinki (FI); Wade A. Montague, Southington, CT (US)

(21) Appl. No.: 14/409,488

(22) PCT Filed: Jun. 24, 2013
(86) PCT No.: PCT/US2013/047278

§ 371 Date: Dec. 19, 2014

Related U.S. Application Data
(60) Provisional application No. 61/667,500, filed on Jul. 3, 2012.

(51) Int. Cl. A62C 35/68

(52) U.S. Cl. CPC A62C 35/68

(57) ABSTRACT

An exemplary method of fire suppression includes introducing a fire suppression fluid into an area by directing the fire suppression fluid along a primary trajectory that is aimed directly at a generally horizontal surface in the area.

### BACKGROUND

A variety of fire suppression systems are known. Traditional systems spray water into an area to extinguish or contain a fire. Traditional systems relied upon a relatively large volume of water to sufficiently wet the contents of the area and to apply water directly onto the fire. Conventional wisdom has been to spray water directly at the walls of an enclosed space such as a room. Some industry standards require spraying water directly onto the walls at a height that is a minimum distance from the ceiling. Some of the water applied to the walls soaks the wall material. Some of the water splashes off the wall and falls onto the floor, furniture or other items in the room.

One drawback to the conventional approach is that it requires a relatively large volume of water or other fire suppression fluid. Soaking the walls and contents of a room increases the likelihood of having to repair or replace the wall materials and furniture or other items in the room, even if they were not damaged by a fire. Another drawback to such systems is that various room sizes and configurations typically require different arrangements of multiple nozzles within the room or area within which fire suppression is desired. This introduces additional complexity for installers and designers of fire suppression systems.

### SUMMARY

An exemplary method of fire suppression includes introducing a fire suppression fluid into an area by directing the fire suppression fluid along a primary trajectory that is aimed directly at a generally horizontal surface in the area.

An exemplary fire suppression system includes at least one conduit configured to carry a fire suppression fluid. A nozzle is connected with the conduit. The nozzle is positioned above a generally horizontal surface in an area that includes a plurality of generally vertical walls. The nozzle has an outlet configured to introduce a fire suppression fluid into the area by directing the fire suppression fluid along a primary trajectory that is aimed directly at the generally horizontal surface.

The various features and advantages of a disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a fire suppression system designed according to an embodiment of this invention.

FIG. 2 schematically illustrates an example fire suppression fluid discharge pattern for one example embodiment.

FIG. 3 schematically illustrates a fire suppression fluid discharge pattern in another embodiment.

### DETAILED DESCRIPTION

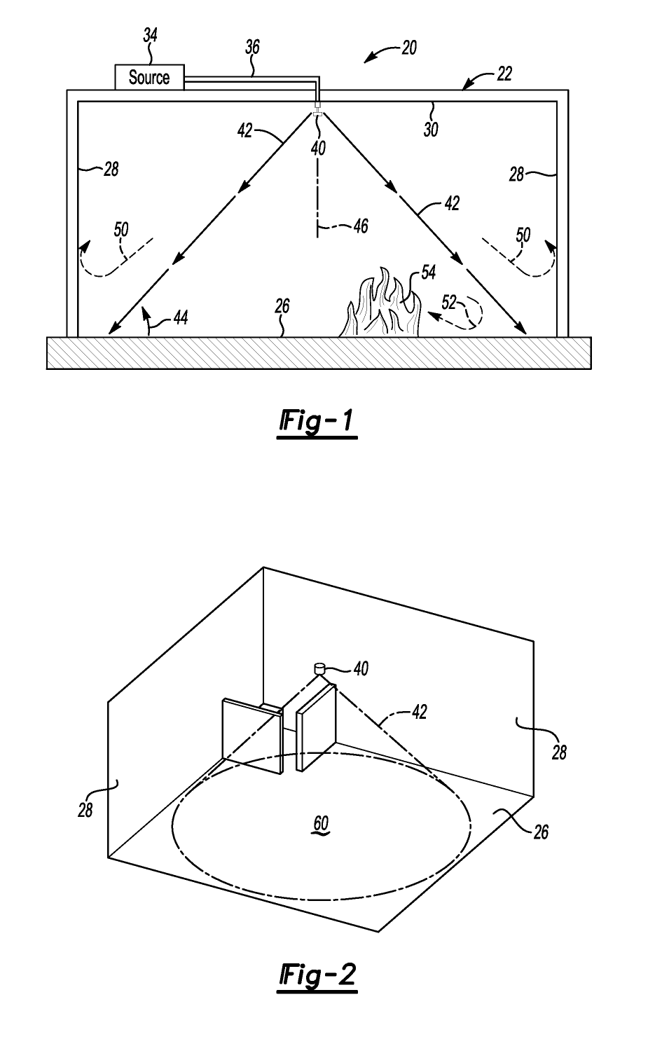

FIG. 1 schematically shows selected portions of a fire suppression system 20 that is used for suppressing or extinguishing a fire within an area 22. In this example, the area 22 is a generally enclosed space such as a room within a building. The area 22 includes a generally horizontal surface 26. In one example, the horizontal surface 26 is a floor. In another example, the horizontal surface 26 is a platform within the area 22. The example area 22 includes a plurality of generally vertical surfaces or walls 28. A ceiling 30 in this example is parallel to the surface 26 and near the top of the walls 28. The ceiling other example areas or rooms may include angled surfaces that are not parallel to the surface 26 or may include surfaces at different heights relative to the surface 26.

Fire suppression fluid, such as water, is provided by a source 34 through a conduit 36 to a nozzle 40. The illustrated example includes a single nozzle 40 positioned within the area 22. The nozzle 40 introduces fire suppression fluid into the area 22 when needed. The nozzle 40 is positioned within the area 22 and configured to direct the fire suppression fluid along a primary trajectory 42 that is aimed directly at the generally horizontal surface 26. This is different than a traditional sprinkler approach in which the primary trajectory of the fire suppression fluid would be aimed directly at the walls 28. In this example, the primary trajectory 42 is aimed directly at a floor surface 26 instead of being aimed at the walls 28.

The example primary trajectory 42 is aligned relative to the generally horizontal surface 26 at an angle schematically shown at 44. The angle 44 in this example is at least 50° relative to the horizontal surface 26. In other words, the primary trajectory 42 is arranged at an angle that is no greater than 40° relative to a vertical reference line schematically shown at 46. A relatively steep angle of orientation of the primary trajectory 42 ensures that most of the fire suppression fluid exiting the nozzle 40 is aimed directly at the floor or generally horizontal surface 26. A steeper angle (e.g., greater than 50° relative to the horizontal surface 26) is used in some examples.

The particular angle of the primary trajectory 42 may be varied depending on the size of the area 22 within which fire suppression or protection is desired. The distance from the nozzle 40 to the horizontal surface 26 and the expected behavior of the fire suppression fluid exiting the nozzle 40 are two factors that are considered for purposes of selecting the angle of orientation of the primary trajectory 42 in one example.

The illustrated example differs from traditional sprinkler arrangements because the fire suppression fluid is not being aimed directly at the walls 28. Instead, the fire suppression fluid is aimed along the primary trajectory 42 directly at the generally horizontal surface 26. In this example, the nozzle 40 is configured to emit a mist of the fire suppression fluid. Some of the mist will tend to deviate from the primary trajectory 42. For example, some of the mist will fall from the primary trajectory toward the horizontal surface 26 closer to the center of the area 22. Other portions of the mist may rise away from the primary trajectory 42 and some droplets may land on a wall surface 28 or the ceiling 30. The majority, however, of the fire suppression fluid mist emitted from the nozzle 40 and introduced into the area 22 follows the primary trajectory 42.

One feature of the illustrated example is that turbulent movement of the fire suppression fluid mist schematically shown at 50 and 52 results in the mist eventually filling or occupying the area 22 with a cool, misty fog. One effect of the turbulent flow schematically shown at 50 is that the amount of mist within the area 22 is effective at suffocating a fire within the area 22 without having to spray the mist directly onto the fire. In this example the turbulent movement comprises a pattern of distribution of the mist. The example pattern includes the mist moving along the primary trajectory until about the location of the generally horizontal surface followed by at least some of the mist moving generally horizontally. At least some of the mist that moves generally horizontally eventually moves generally upward. This movement in an outward direction away from a center of the area 22 is schematically represented by the arrows 50 while such movement in an inward direction toward a center of the area is shown by the arrow 52.

In the illustrated example, some of the turbulent mist movement 52 within the area 22 results in some of the mist being directed near a base of a fire 54 on the surface 26. Introducing mist toward the base of the fire 54 from a side of the fire is believed to have superior fire suppression effects compared to attempts to douse a fire by applying water on top of the fire. Of course, the primary trajectory 42 may direct some of the fire suppression fluid at the top of a fire depending on the fire location within the area 22 but that is not necessary for fire suppression with the example system 20. The primary trajectory 42 in the illustrated example allows for cool, moist air to be drawn toward the base of the fire 54 for better fire suppression results regardless of the specific fire location on or near the surface 26.

FIG. 2 schematically illustrates an example pattern of fire suppression fluid distribution within an area 22′. The illustration of FIG. 2 effectively shows the arrangement of FIG. 1 in three-dimensional form. The figure illustrates how a generally circular area 60 fits within a cone of fire suppression fluid mist following along the primary trajectory 42.

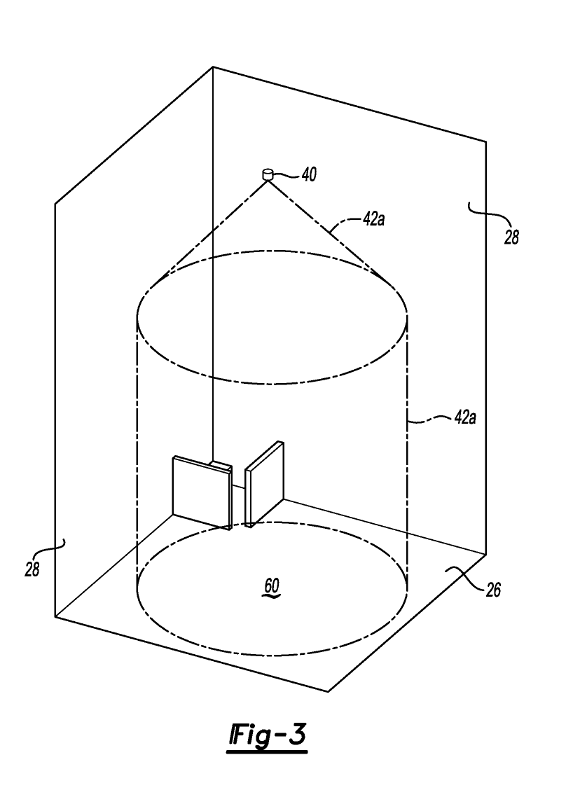

FIG. 3 illustrates another arrangement in which the primary trajectory includes directing the fire suppression fluid in a downward and radially outward direction from the nozzle 40. In this example, the speed and pressure at which the fire suppression fluid is ejected from the nozzle 40 results in a majority of the mist following the primary trajectory pattern shown at 42a. As can be appreciated from the illustration, the position of the nozzle 40 relative to the horizontal surface 26 includes a relatively large distance such as a distance on the order of 20 feet. The primary trajectory 42a in this example results in a majority of the mist being aimed directly at the surface 26 instead of it being aimed at any of the walls 28. In an example configured consistent with the schematic illustration of FIG. 3, a mist of fire suppression fluid follows the primary trajectory 42a and movement of the mist within the area 22 is effective to fill the area 22 with a fog of cool, moist air.

One feature of the illustrated examples is that they allow for less fire suppression fluid to be used because there is no requirement for wetting down the wall surfaces within an area where fire suppression is desired. Another feature of the illustrated examples is that they provide a distribution of fire suppression mist within a room that is effective to more quickly extinguish or suppress a fire within an area where protection is desired.

Another feature of the illustrated examples is that it is possible to arrange a single nozzle within an area to provide fire suppression and protection. This simplifies the task of designing and installing a fire suppression system for a given area. For example, a room that includes a soffit in the ceiling does not require special design considerations because the illustrated examples direct the fire suppression fluid toward the floor or surface 26 instead of aiming it at the walls 28. The ability to use a single sprinkler for an area also reduces the cost associated with parts and labor.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of fire suppression, comprising:
introducing a fire suppression fluid into an area by directing the fire suppression fluid along a primary trajectory that is aimed directly at a generally horizontal surface in the area.

2. The method of claim 1, comprising establishing a pattern of distribution of a mist of the fire suppression fluid in the area, the pattern including the mist moving along the primary trajectory until about the location of the generally horizontal surface followed by at least some of the mist moving generally horizontally and then at least a portion of the some of the mist moving generally upward.

3. The method of claim 2, wherein the pattern includes at least some of the mist moving generally horizontally toward a base of a fire in the area.

4. The method of claim 2, wherein the mist moving along the pattern is operative to suffocate a fire in the area.

5. The method of claim 1, comprising
introducing the fire suppression fluid as a mist; and
establishing a pattern of turbulent distribution within the area that results in the mist essentially filling the area.

6. The method of claim 1, comprising
providing a nozzle that establishes the primary trajectory; and
positioning the nozzle above the generally horizontal surface a distance so that the fire suppression fluid exiting the nozzle is aimed at the generally horizontal surface.

7. The method of claim 6, wherein the nozzle establishes at least a portion of the primary trajectory at an angle that is greater than about 50 degrees relative to the generally horizontal surface.

8. The method of claim 1, wherein the generally horizontal surface is a floor.

9. The method of claim 1, wherein the generally horizontal surface is a platform.

10. The method of claim 1, wherein the area comprises a portion of a structure having a floor and a plurality of generally vertical walls and wherein the primary trajectory is aimed at the floor instead of at any of the walls.

11. A fire suppression system, comprising:
at least one conduit configured to carry a fire suppression fluid;
a nozzle connected with the conduit, the nozzle being positioned above a generally horizontal surface in an area that includes a plurality of generally vertical walls, the nozzle being configured to introduce a fire suppression fluid into the area by directing the fire suppression fluid along a primary trajectory that is aimed directly at the generally horizontal surface.

12. The system of claim 11, wherein the nozzle is positioned and configured to establish a pattern of distribution of a mist of the fire suppression fluid in the area, the pattern including the mist moving along the primary trajectory until about the location of the generally horizontal surface followed by at least some of the mist moving generally horizontally and then at least a portion of the some of the mist moving generally upward.

13. The system of claim 12, wherein the pattern includes at least some of the mist moving generally horizontally toward a base of a fire in the area.

14. The system of claim 12, wherein the mist moving along the pattern is operative to suffocate a fire in the area.

15. The system of claim 11, wherein the nozzle is configured to release the fire suppression fluid as a mist in a manner that is effective to establish a pattern of turbulent distribution within the area that results in the mist essentially filling the area.

16. The system of claim 11, wherein the nozzle is positioned above the generally horizontal surface a distance so that the fire suppression fluid exiting the nozzle is aimed at the generally horizontal surface.

17. The system of claim 16, wherein the nozzle outlet is configured to establish at least a portion of the primary trajectory at an angle that is at least about 50 degrees relative to the generally horizontal surface.

18. The system of claim 11, wherein the generally horizontal surface is a floor.

19. The system of claim 18, wherein the primary trajectory is aimed at the floor instead of at any of the walls.

20. The system of claim 11, wherein the generally horizontal surface is a platform.
